(19) United States
(12) Patent Application Publication
(10) Pub. No.: US 2005/0198681 A1
(43) Pub. Date: Sep. 8, 2005

(54) Playout buffer management to minimize startup delay

(75) Inventor: Daniel John Park, Beaverton, OR (US)

Correspondence Address: Robert D. Varitz;ROBERT D. VARITZ, P.C., 2007 S.E. Grant Street, Portland, OR, 97214, US

(73) Assignee: Sharp Laboratories of America, Inc.

(21) Appl. No.: 10/795,665

(22) Filed: Mar. 8, 2004

(51) Int. Cl. H04N 7/173; H04N 7/16

(52) U.S. Cl. 725/89; 725/134; 725/142

(57) ABSTRACT

A method of playout buffer management includes delivering AV data to a destination device at a rate greater than the rate at which the destination device consumes data; rendering of AV data upon receipt of a first AV data packet while simultaneously filling a playout buffer; and flushing the playout buffer upon receipt of a command taken from the group of commands consisting of change of AV program, receipt of a new AV stream following a fast forward or fast reverse command, a pause command and a stop command.

### FIELD OF THE INVENTION

This invention relates to stream audio/visual (AV) techniques, and specifically to a method of managing a playout buffer to minimize delays frequently present at startup and program change.

### BACKGROUND OF THE INVENTION

Data packets delivered across a network are subject to delivery delay due to factors such as packet processing, network congestion, transmission errors, and transmission scheduling. The delay experienced by a packet will vary between a minimum value and a maximum acceptable value, before discard. The difference between the minimum and maximum delay values is called the delay jitter.

Audio/visual (AV) data transmitted from a source device to a rendering device. i.e., speakers and video display, across a network is often required to be submitted to the rendering hardware with very precise, regular timing. Because the network introduces delay jitter on the delivery of packets with AV data, even though the packets are submitted to the transmitter with precise, regular timing, the receiver must compensate for the delay jitter by buffering the received packets for a period of time in a playout buffer.

When a system uses a playout buffer to compensate for delay jitter, the receiving device does not begin the rendering of the AV data until the total delay for an individual packet is greater than or equal to the maximum delay for any packet delivery. The user will thus experience a delay of at least the maximum delivery delay from the time playback of AV programming is initiated at the source before it will be rendered at the receiving device. This delay is particularly noticeable when the user switches between AV programs. e.g., channel surfing, track selection, fast forward, fast reverse. It is at this time, when the user is actively commanding changes to the AV steam and watching for results, that the total delay, from control action to rendering effect, is most noticeable.

The current solution in network systems is to wait for the playout buffer to fill, requiring the user to wait through a startup delay. Some systems do not use playout buffers in order to eliminate this source of delay, however, such systems are unable to perform retransmission on packet error, and are subject to rendering anomalies if the network delays change from time to time.

U.S. Pat. No. 6,157,653, to Kline et al., granted Dec. 5, 2000, for Method and apparatus for adaptive smoothing delay for packet voice applications, describes a method of measuring the waiting time in the playout buffer, generates a histogram of the delays and adjusts the playout delay accordingly.

U.S. Pat. No. 6,085,252, to Zhu et al., granted Jul. 4, 2000, for Device, system and method for real-time multimedia streaming, describes a method of adjusting the bandwidth assigned to the connection based on current error rates.

U.S. Pat. No. 5,553,041, to Inagawa et al., granted Sep. 3, 1996, for Disc data reproducing apparatus and signal processing unit for preventing underflow and overflow, describes a CD player buffering for anti-skip. The reference describes buffering in CD players to reduce tracking errors in the CD mechanism as a result of e.g., scratches, vibration, etc.

U.S. Pat. No. 5,534,937, to Zhu et al., granted Jul. 9, 1996, for Minimum-delay jitter smoothing device and method for packet video communications, describes a method of jitter smoothing at the video frame level.

WO9834405 A1, of Cannon et al., Published Aug. 6, 1998, for VCR-like functions rendering video on demand, describes video-on-demand control functions, and further describes the playout buffer.

WO9722201 A2, of Campbell et al., Published Jun. 19, 1997, Method of and system for transmitting and/or retrieving real-time video and audio information over performance-limited transmission systems, describes a video delivery system.

### SUMMARY OF THE INVENTION

A method of playout buffer management includes delivering AV data to a destination device at a rate greater than the rate at which the destination device consumes data; rendering of AV data upon receipt of a first AV data packet while simultaneously filling a playout buffer; and flushing the playout buffer upon receipt of a command taken from the group of commands consisting of change of AV program, receipt of a new AV stream following a fast forward or fast reverse command, a pause command and a stop command.

It is an object of the invention to provide reduced startup delay of AV material while providing sufficient delay within the network for the device receiving AV program material to perform its network error handling functions during the normal AV playback.

Another object of the invention is to provide a source device with a pre-fetch capability so that additional AV material from the AV store may be secured and then to provide the receiving device with the capability to “burst” data at AV startup to fill its playout buffer.

A further object of the invention is to provide the source device with the ability to identify the new AV stream so that the destination device can flush its playout buffer of previously transmitted, but subsequent to the start of the new AV stream, unwanted AV data.

Yet another object of the invention is to configure packets of an AV program to be supplied in a mode of low quality, e.g., fast forward (FF) and fast reverse (FR), by the source device so that they are received with lower error recovery capabilities in exchange for their reduced maximum delivery delay.

This summary and objectives of the invention are provided to enable quick comprehension of the nature of the invention. A more thorough understanding of the invention may be obtained by reference to the following detailed description of the preferred embodiment of the invention in connection with the drawings.

### BRIEF DESCRIPTION OF THE DRAWINGS

FIG. 1 is a block diagram of an audio/visual startup procedure of the method of the invention.

FIG. 2 is a block diagram depicting switch between audio/visual programs.

FIG. 3 is a block diagram of the source device of the invention.

FIG. 4 is a block diagram of the destination device of the invention.

### DETAILED DESCRIPTION OF THE PREFERRED EMBODIMENTS

This invention eliminates the playout buffer delay at the startup of a prerecorded audio/visual (AV) stream, and also eliminates the playout buffer delay when the AV stream transitions from one AV program to another. This reduces the total delay perceived by a user from the time the user commands the start or change in a programming stream to the time it is rendered. The invention uses the ability of the network system to deliver AV data at rates that exceed the rate at which the rendering hardware consumes the AV data to fill the playout buffer over an initial (short) period to regain the error protection provided by the playout buffer.

This invention also reduces the latency between commands issued by the user and their displayed action. The PAUSE and STOP commands may be acted on locally, eliminating network delays while the AV source acts on the commands after the network delays. Commands such as fast forward (FF) and fast reverse (FR), which require action at the source, but which may be rendered at reduced quality, have their command latency reduced by the minimazation of the playout buffer at the rendering device.

In many networking systems, e.g., the Avalanche PLC-AV networking system of Sharp KK, bandwidth in excess of that required to carry AV data is available for a connection from the source device to the destination device. Bandwidth in excess of the required minimum is used for such purposes as retransmission of errored data packets and to carry control information. The additional bandwidth allocated for errored packets must be sufficient to satisfy two needs: (1) the ability to deliver a retransmitted packet to the destination before the packet has exceeded its maximum delay, given that packets are errored randomly, wherein the random packet error rate is specified to be less than some value, e.g., ×10⁻³; and (2) the ability to deliver retransmitted packets to the destination before the packets have exceeded their maximum delay when the transmission channel experiences a channel interruption of less than a specified duration, e.g., 50 ms.

The method of the invention uses the additional available bandwidth not only for packet retransmission but also to deliver the program material at a rate exceeding the rate at which it is submitted to the rendering hardware. This allows the rendering hardware to begin the rendering process at the reception of the first data packet, thus eliminating startup delay due to playout buffer filling, while the playout buffer is filled to its normal level, sufficiently deep to absorb packet retransmissions.

The method of the invention also flushes the playout buffer of the receiving device anytime the current AV stream is terminated and a new AV stream is started. Flushing the playout buffer of residual, e.g., unwanted, AV program material eliminates playout buffer delay, minimizing the reaction time of the system to user commands that change the AV stream. Again, the playout buffer is subsequently filled to its normal level as the source device delivers the AV program data at a rate that exceeds the rendering hardware's consumption of the AV program data for a period of time.

The method of the invention further minimizes the latency from the issuance of certain AV commands, such as FF and FR, to the display of their action by flushing the playout buffer of the rendering device upon receipt of the first delivered packets of the new AV stream. The source device then maintains the playout buffer at its minimum level by transmitting packets representing the rendering of the FF or FR mode at their normal rate by setting the time-to-die (TTD), i.e., the maximum time the packets are held in the network until discarded, to the maximum value of the network delay without retransmissions. The setting of the time-to-die to this value, effectively minimizes the playout buffer size to that required for delay jitter from scheduling, and packet processing, e.g., there is delay added to the AV stream to compensate for retransmission.

However, a negative effect of the method of the invention is related to the quality of the AV rendering because errors in the delivery of AV packets in the period between the time when the AV stream is started and the time when the playout buffer is filled to its normal level, or when the playout buffer depth is reduced, are more likely to be detected by the user. The playout buffer is more likely to underflow on a packet error condition, causing a disruption in the AV rendering because it may not have been filled to a sufficient level to absorb the time required to retransmit the errored packet. However, this tradeoff is acceptable because: (1) the user is much more likely to be annoyed at control loop delays, e.g., command-to-effect, than rendering errors; (2) the probability of a packet error from the time a AV program is changed to when the playout buffer has been refilled is low; and (3) errors in AV material that is transitioning or is intrinsically of low quality, i.e., FF and FR, are less likely to be an annoyance to the user than normal rendering.

Important features of the method of the invention include: (1) reducing startup delay of the AV material to its minimum while allowing the device receiving the AV program material to perform its network error handling functions during normal AV playback; (2) pre-fetch of additional AV material by the source device from the AV store and transmission of “bursts” of this data to the receiving device at AV startup to fill the playout buffer; (3) identification of a new AV stream by the source device so that the destination device can flush its playout buffer of previously transmitted, i.e., unwanted, AV data, thus reducing the startup of the new AV stream to a minimum; and (4) supply of packets of an AV program in a mode of low quality, e.g., FF and FR, by the source device, which are received with lower error recovery capabilities by the rendering device in exchange for reduced delivery delay.

Referring now to the several drawing figures, the following abbreviations are used:

| | |
|---|---|
| CurTime: | The system-wide current time-of-day value. |
| MinNetDelay: | The minimum delay of the network. |
| MaxNetDelay: | The maximum delay of the network. |
| InterPacketTime: | The playout time between AV packets. |
| TTD: | Time-to-Die of an AV packet. |
| TTD_{new}: | Time-to-Die of a packet in an AV program |
| | stream. |
| TTD_{old}: | Time-to-Die of an AV packet in a previous AV |
| | stream. |
| NextToPlayTTD: | The time-to-die (TTD) time stamp of the packet |
| | at the head of the playout buffer. |
| NormalPlayoutDepth: | The average depth of the playout buffer when |
| | network delivery is error free. |

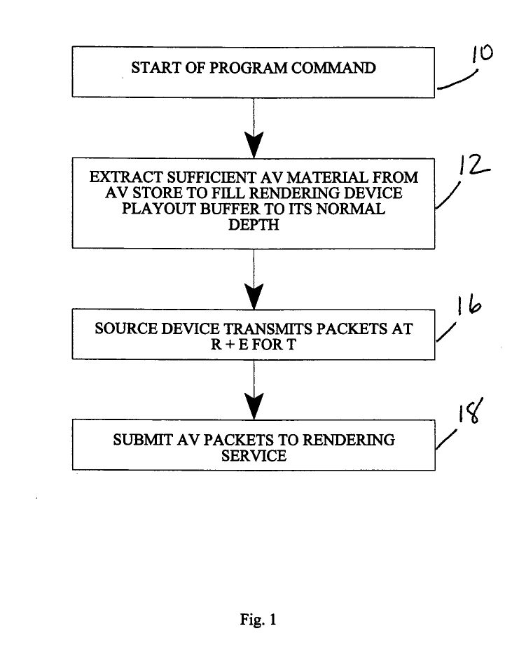

Procedure at Startup of AV: Referring to FIG. 1,

1. A user commands start of AV program, e.g., PLAY, 10.

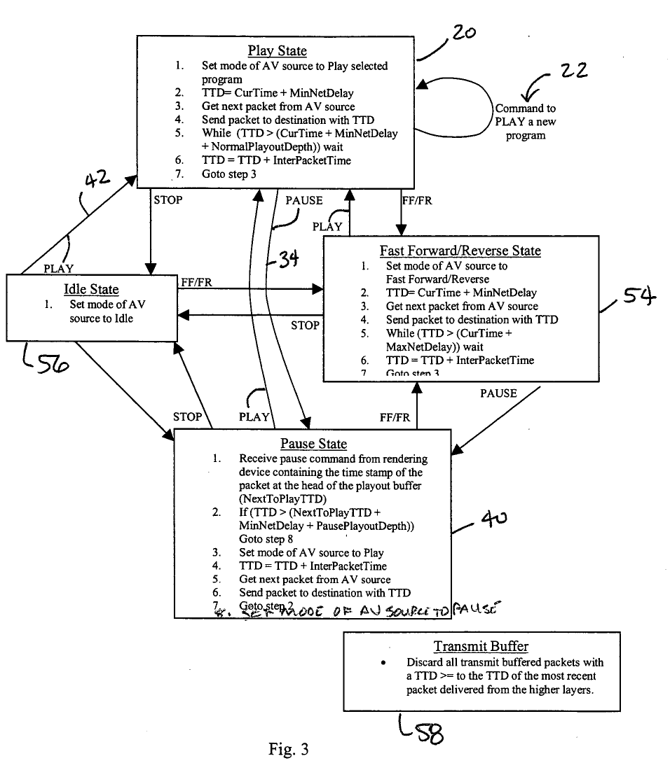

2. The source device obtains sufficient AV material from the AV store, 12, to fill the destination device's playout buffer to its normal depth. The source device begins transmitting packets with AV program at (R+E) data rate for time T, 16. R is the rate at which the rendering device consumes AV data. E is the excess bandwidth used at startup to fill the playout buffer. T is the time required in an error free condition to fill the playout buffer: ExT=the number of AV data packet required to fill the playout buffer at the receiving device, 18, which is depicted as PLAY State, at 20 in FIG. 3.

3. The receiving device immediately submits the first AV data packet to the rendering service when it is received.

4. The receiving device continues to submit AV packets at rate R to the rendering service.

5. After time T, the source device transmits AV packets at rate R to the receiving device. The source is generating AV packets at the same rate as the rendering service consumes them and there are sufficient packets in the rendering device's playout buffer to absorb delays due to retransmission of errored packets.

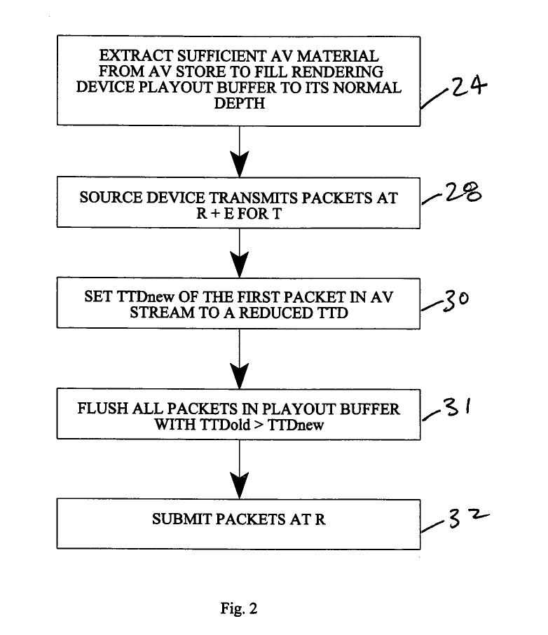

Procedure at Switch of AV Program: Referring to FIGS. 2 and 3:

1. The user commands change of AV program, e.g., select new channel, station or track, 22.

2. The source device obtains sufficient AV material from the AV store, 24, to fill the destination device's playout buffer to its normal depth. The source device begins transmitting packets with AV program at (R+E) data rate for time T, 28, as described above. In addition, the TTD_{new} of the first packet of the new program AV stream is set to a reduced time, 30. The TTD_{new} of the first packet of the new AV stream is far enough into the future to allow for delay jitter expected for only a singe transmission. Subsequent TTD values of packets in the new stream are incremented by the time between the expected playout of the packets and the time which the packets are transmitted at a rate of (R+E) for time T. thereafter, packets are transmitted at rate R.

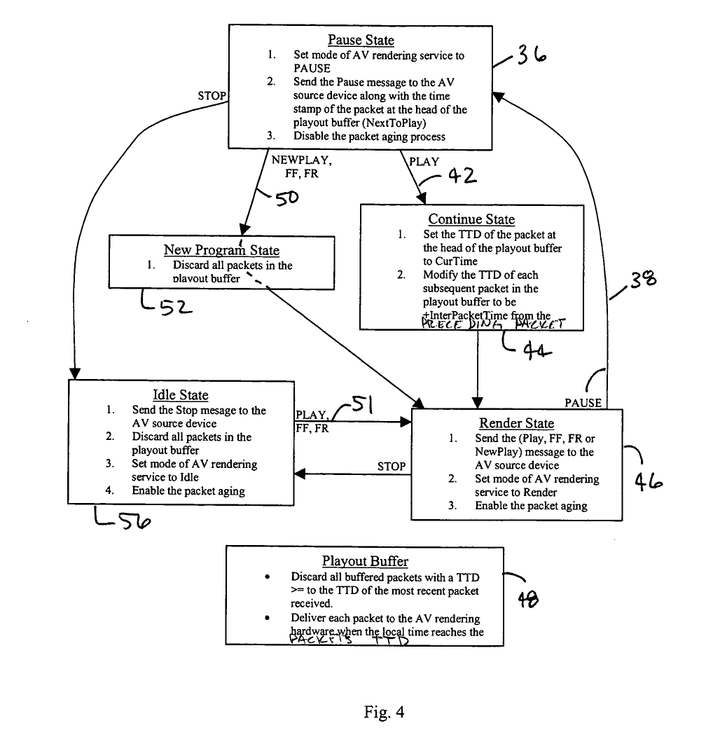

3. The receiving device detects that the TTD_{new} of the first packet of the new AV stream is earlier than previously received packets and flushes all packets stored in the playout buffer with TTD_{old} values greater (later) than the new packet, 48 in FIG. 4, 31 in FIG. 2.

4. The receiving device continues to submit AV packets at rate R to the rendering service, and, after time T, the source device transmits new AV packets at rate R to the receiving device, 32. For an established, ongoing AV stream, excess bandwidth (E) is used as needed for retransmissions.

Procedure for Pause: Referring to FIGS. 3 and 4:

1. The user commands a PAUSE, 38, in the destination device.

2. The destination device freezes the rendering service, entering the PAUSE State, 36.

3. The destination device forwards the PAUSE message to the source device, along with the current depth of the playout buffer.

4. The destination device disables its packet aging so that packets held in the playout buffer are not discarded. This allows the user to release the PAUSE command at a later time, and continue from the current point in the AV source with no network delay.

5. The source device continues to send AV packets to the destination device until the playout buffer is of sufficient depth to cover the additional delay that may be experienced from the time the user commands a restart of the AV material to when additional packets can be delivered by the source.

6. The AV source is PAUSED, 40.

Procedure for Un-Pause (Continue):

1. User commands the release of the PAUSE to continue from the current point, 42.

2. The destination device modifies the TTD of each packet in the playout buffer by increasing its value by the amount of time that the PAUSE command was in effect, 44.

3. The destination device forwards the command that released the PAUSE to the source device, 46.

4. Enable the rendering service and the aging process for normal operations.

Procedure for Un-Pause (Non-Continuous):

1. The user commands the release of the PAUSE with a change in program, e.g., NEWPLAY, FF, FR, 50.

2. The destination device discards all packets in the playout buffer, 52. These packets were cached in the event that the user would continue and are now of no value.

3. Enable the rendering service and the aging process for normal operations, 46, and forward the command to the source device, which causes transition to the PLAY State, 20.

4. The source device sends the first packet of the new AV stream with the reduced TTD, 20. Subsequent packets are sent to refill the playout buffer and then thereafter sent at a rate to match the rate at which packets are rendered.

Procedure for FF/FR

1. A FF/FR command 50, 51 is given to the destination device. If the destination device is already in the PAUSE state, the FF/FR command causes the destination device to briefly enter the NEW PROGRAM State, 52. The command is then sent to the RENDER State, 46.

2. The FF/FR State, 54, sets the source device to the FF/FR condition; determined the TTD as being equal to the current time plus the MinNetDelay time; secures the next packet from the AV source; sends that packet to the destination device with the TTD; and continues to send AV packets to the destination device at rate R with a minimum delay until the devices are commanded to enter the FF/FR mode, e.g., by entry of a PLAY, STOP or PAUSE command.

Procedure for STOP

1. A STOP command is received by the rendering, destination device and sent by RENDER State 46 to IDLE State 56, which is located in both the destination device and source device.

2. The STOP command sets the IDLE State of the source device to IDLE.

3. The STOP command directs the IDLE State of the destination device to discard all packets in the playout buffer, and set the state of the destination device to IDLE.

Note: ARQ and packet retransmission operate independently from the above procedures. The TTD value set in each packet controls when a packet is discarded. If a packet's TTD is set to a value close in time to its generation, then the packet may not be able to be retransmitted if it is in error. This is the desired behavior.

When the source device changes AV programs, there may be material from the previous program in the transmit buffer, 58. These packets from the previous AV steam are appropriately discarded when the packet from the new AV stream is received and its TTD value is detected to be earlier than the packets currently buffered.

Thus, a method for playout buffer management has been disclosed. It will be appreciated that further variations and modifications thereof may be made within the scope of the invention as defined in the appended claims.

1. A method of playout buffer management comprising:
commanding start of an AV program;
in a source device, obtaining sufficient AV material from an AV store in the form of data packets;
filling a destination device's playout buffer to a normal depth with data packets;
in the source device, transmitting packets with AV program at (R+E) data rate for time T;
in the destination device, submitting the first AV data packet to a rendering service as the first AV data packet is received;
in the destination device, continuing to submit AV packets at rate R to the rendering service; and
after time T, in the source device, transmitting AV packets at rate R to the destination device, and generating AV packets at the same rate as the packets are consumed by the rendering service to maintain sufficient packets in the destination device's playout buffer to absorb delays due to retransmission of errored packets.

2. The method of claim 1 wherein a program is changed by:
commanding change of an AV program;
in the source device, obtaining sufficient AV material from the AV store to fill the destination device's playout buffer to its normal depth;
in the source device, transmitting packets with AV program at (R+E) data rate for time T, which includes setting the TTD_{new} of the packets of the new program AV stream to a reduced time, wherein the TTD_{new} of the first packet is far enough into the future to allow for delay jitter expected for only a singe transmission;
in the destination device, detecting that the TTD_{new} of the first packet of the new AV stream is earlier than a TTD_{old} of previously received packets, flushing all packets stored in the playout buffer with TTD_{old} values greater than TTD_{new}; continuing to submit AV packets at rate R to the rendering service, and, after time T, in the source device, transmitting AV packets at rate R to the destination device.

3. The method of claim 1 wherein a program is paused by:
issuing a PAUSE command;
in the destination device, freezing the rendering service and forwarding the PAUSE command and the current depth of the playout buffer to the source device; disabling the packet aging so that packets held in the playout buffer are not discarded;
in the source device, continuing to send AV packets to the destination device until the playout buffer is of sufficient depth to cover the additional delay which may be experienced at restart of the AV program; and
pausing the AV source.

4. The method of claim 3 wherein a program is continued by:
releasing the PAUSE of the source device;
in the destination device, modifying the TTD of each packet in the playout buffer by increasing its value by the amount of time that the PAUSE command was in effect; and
enabling the rendering service and the aging process for normal operations.

5. The method of claim 1 which further includes delivering AV data to the destination device at a rate greater than the rate at which the destination device consumes data.

6. The method of claim 1 which includes rendering of data upon receipt of the first AV data packet while simultaneously filling the playout buffer.

7. The method of claim 1 which includes flushing the playout buffer upon receipt of a command taken from the group of commands consisting of change of AV program, receipt of a new AV stream following a fast forward or fast reverse command, and a stop command.

8. A method of playout buffer management comprising:
delivering AV data to a destination device at a rate greater than the rate at which the destination device consumes data;
rendering of AV data upon receipt of a first AV data packet while simultaneously filling a playout buffer; and
flushing the playout buffer upon receipt of a command taken from the group of commands consisting of change of AV program, receipt of a new AV stream following a fast forward or fast reverse command, and a stop command.

9. The method of claim 8 which further includes:
commanding start of an AV program;
in a source device, obtaining sufficient AV material from an AV store in the form of data packets;
filling a destination device's playout buffer to a normal depth with data packets;
in the source device, transmitting packets with AV program at (R+E) data rate for time T;
in the destination device, submitting the first AV data packet to a rendering service as the first AV data packet is received;
in the destination device, continuing to submit AV packets at rate R to the rendering service; and
after time T, in the source device, transmitting AV packets at rate R to the destination device, and generating AV packets at the same rate as the packets are consumed by the rendering service to maintain sufficient packets in the destination device's playout buffer to absorb delays due to retransmission of errored packets.

10. The method of claim 9 wherein a program is changed by:
commanding change of an AV program;
in the source device, obtaining sufficient AV material from the AV store to fill the destination device's playout buffer to its normal depth;
in the source device, transmitting packets with AV program at (R+E) data rate for time T, which includes setting the TTD_{new} of the packets of the new program AV stream to a reduced time, wherein the TTD_{new} of the first packet is far enough into the future to allow for delay jitter expected for only a singe transmission;
in the destination device, detecting that the TTD_{new} of the first packet of the new AV stream is earlier than a TTD_{old} of previously received packets, flushing all packets stored in the playout buffer with TTD_{old} values greater than TTD_{new}; continuing to submit AV packets at rate R to the rendering service, and, after time T, in the source device, transmitting AV packets at rate R to the destination device.

11. The method of claim 9 wherein a program is paused by:
issuing a PAUSE command;
in the destination device, freezing the rendering service and forwarding the PAUSE command and the current depth of the playout buffer to the source device; disabling the packet aging so that packets held in the playout buffer are not discarded;
in the source device, continuing to send AV packets to the destination device until the playout buffer is of sufficient depth to cover the additional delay which may be experienced at restart of the AV program; and
pausing the AV source.

12. The method of claim 11 wherein a program is continued by:
releasing the PAUSE of the source device;
in the destination device, modifying the TTD of each packet in the playout buffer by increasing its value by the amount of time that the PAUSE command was in effect; and
enabling the rendering service and the aging process for normal operations.
